(19) United States
(12) Patent Application Publication
(10) Pub. No.: US 2009/0296383 A1
(43) Pub. Date: Dec. 3, 2009

(54) ILLUMINATION SYSTEM, SHELF-LIGHTING SYSTEM AND WALL-WASHER LIGHTING SYSTEM

(75) Inventors: Adriaan Valster, Eindhoven (NL); Petrus Gerardus Josephus Maria Nuyens, Eindhoven (NL); Jozef Henricus Cornelius Hoens, Waalre (NL); Martijn Riemeijer, Eindhoven (NL)

Correspondence Address: PHILIPS INTELLECTUAL PROPERTY & STANDARDS, PO BOX 3001, BRIARCLIFF MANOR, NY, 10510-8001, US

(73) Assignee: KONINKLIJKE PHILIPS ELECTRONICS N.V., EINDHOVEN (NL)

(21) Appl. No.: 11/915,312

(22) PCT Filed: May 8, 2006
(86) PCT No.: PCT/IB2006/051435

§ 371 Date: Aug. 14, 2009

(30) Foreign Application Priority Data
May 25, 2005 (EP) 05104464.2

(51) Int. Cl. F21V 9/00; F21V 7/00

(52) U.S. Cl. 362/231; 362/296.01

(57) ABSTRACT

An illumination system for illuminating an object (1) arranged in the vicinity of the illumination system. The illumination system comprises a plurality of light emitters (R, G, B) arranged along a line for emitting light substantially away from the object. A complex-shape reflector (11) is arranged in the vicinity of the plurality of light emitters for reflecting light emitted by the plurality of light emitters towards the object. In operation, light emitted by the plurality of light emitters only reaches the object via the complex-shape reflector. The complex-shape reflector is designed to obtain a substantially homogenous illumination of the object. Preferably, a characteristic dimension dle of the light emitters and a distance dₑᵣ between the light emitters and the complex-shape reflector meet the following relation: Formula (I).

### FIELD OF THE INVENTION

The invention relates to an illumination system for illuminating an object, the illumination system comprising a plurality of light emitters and a reflector.

The invention also relates to a shelf-lighting system provided with such an illumination system.

The invention also relates to a wall-washer lighting system comprising such an illumination system.

### BACKGROUND OF THE INVENTION

Such illumination systems are known per se. They are used, inter alia, as a shelf-lighting system for illuminating an object or as wall-washer lighting system for illuminating a wall. Shelf-lighting systems are employed, for instance, in shops for illuminating products or in offices or at home in a (book) cupboard for illuminating objects. In a shelf-lighting system, generally, the objects to be illuminated are positioned on a first shelf whereas the shelf-lighting system is mounted on a second shelf arranged above the first shelf. Preferably, the shelf-lighting system is mounted at an edge of the second shelf. Other embodiments of a shelf are possible, such as illumination systems mounted at some distance from the shelves to be illuminated, or mounted at a different orientation with respect to the shelves. A wall-washer lighting system is mounted flush onto a flat surface such as a wall or a ceiling of a room. Light emitted by the wall-washer lighting system “washes” a nearby flat surface such as a wall, floor or ceiling, for example perpendicular to the mounting surface, with illumination. The illumination systems are also used as road signs above highways.

Generally, such illumination systems comprise mercury vapor discharge lamps.

The English abstract of the Japanese patent application JP-A 10-040720 discloses a wall bracket luminaire comprising a luminaire main body mounted on a wall face and having an upper light-transmission opening at the top face and a lower light-transmission opening at the bottom face of the main luminaire main body. A high-intensity metal-halide discharge lamp with a substantially horizontally light emission portion is housed inside the main body. In the upper half of the luminaire body an elliptical reflection plate is provided. The reflection plate does not shield direct light toward the upper light-transmission opening but reflects a part of the upwardly emitted light by the metal halide lamp to the lower light transmission opening of the luminaire for reducing effects of color differences in the light emitted by the metal-halide lamp in the direction of the upper light-transmission opening as compared to the lower light-transmission opening.

A drawback of the known illumination system is that the light emission is not sufficiently uniform.

### SUMMARY OF THE INVENTION

The invention has for its object to eliminate the above disadvantage wholly or partly. According to the invention, this object is achieved by an illumination system for illuminating an object arranged in the vicinity of the illumination system, the illumination system comprising:

a plurality of light emitters arranged along a line for emitting light substantially away from the object,

a complex-shape reflector arranged in the vicinity of the plurality of light emitters for reflecting light emitted by the plurality of light emitters towards the object,

in operation, light emitted by the plurality of light emitters substantially only reaching the object via the complex-shape reflector for substantially homogenously illuminating the object.

The illumination system according to the invention is a so-called indirect illumination system. The majority of the light emitted by the plurality of light emitters is not directly incident on the object but can only reach the object via a reflection at the complex-shape reflector. The plurality of light emitters is arranged such that light is emitted away from the object to be illuminated. The complex-shape reflector is designed to reflect the light emitted by the light emitters. The form of the complex-shape reflector is optimized by well-known computer programs calculating the shape of the reflector dependent on the desired illumination of an object as a function of the distance between the object and the illumination system. In designing the complex-shape reflector the emitted ray angles by the complex-shape reflector are mapped onto positions at the target area (the object to be illuminated). In this manner, the ray density in the directions after reflection of the light emitted by the plurality of light-emitters can be varied allowing the target area to be illuminated in a desired manner.

In the known illumination system most of the light is projected in the relatively close vicinity of the illumination system whereas at distances further away from the illumination system relatively little light is projected. This results in a non-uniform illumination of the object, which is undesirable. In particular, if the illumination system is mounted above the object, there is relatively much light on top of the object whereas the illumination on lower parts of the object, for instance, parts of the object facing the viewer, is relatively low, the amount of light rapidly diminishing from the top towards the bottom of the object, resulting in an inhomogeneous illumination of the object. In the illumination system according to the invention the combination of the plurality of light emitters arranged along a line and the complex-shape reflector provides a relatively uniform illumination of the object. Light emitted by the illumination system according to the invention is distributed for obtaining a relatively homogeneous illumination over a certain target area.

Preferably, the dimensions of the light emitters in the illumination system according to the invention are relatively small as compared to the dimensions of the complex-shape reflector. To this end, a preferred embodiment of the illumination system according to the invention is characterized in that a characteristic dimension dₗₑ of the light emitters and a distance dₑᵣ between the light emitters and the complex-shape reflector meet the following relation:

$$\frac{{d}_{le}}{{d}_{er}} \leq 0.5 .$$

Preferably, each of the light emitters resembles a “point” source. For point light sources, the shape of the complex-shape reflector can be determined beforehand with relatively high precision by calculating light rays emitted by the light emitters and reflected by the complex-shape reflector.

Preferably, the light emitters comprise a plurality of light-emitting diodes (LEDs) of distinct primary colors or of a single primary color. LEDs can be light sources of distinct primary colors, such as, for example the well-known red (R), green (G), or blue (B) light emitters. In addition, the light emitter can have, for example, amber or cyan as primary color. These primary colors may be either generated directly by the light-emitting-diode chip, or may be generated by a phosphor upon irradiance with light from the light-emitting-diode chip. In the latter case, also mixed colors or white light is possible as one of the primary colors. Generally, the (colored) light emitted by the light sources is mixed in an imaginary light-mixing chamber formed by the arrangement of the light emitters and the complex-shape reflector. In addition, it is known to employ a controller with a sensor and some feedback algorithm in order to obtain high color accuracy.

The characteristic dimensions of LEDs are relatively small. The smaller the characteristic dimension of the light emitters, the smaller the shape of the illumination system can be obtained. This is an advantageous property of the illumination system according to the invention. Because of the folded light path generated by the complex-shape reflector the optimal mixing length is increased and an improved mixing of individually colored light emitters is achieved.

Preferably, the complex-shape reflector comprises an elliptical shape for obtaining a concentration of light beams. The shape of the complex-shape reflector resembles an elliptical shape. Light rays emitted by the plurality of light emitters and reflected by the complex-shape reflector are converged and a concentration and/or crossover of light beams is obtained at a location relatively close to the illumination system. Preferably, light emitted by the plurality of light emitters is reflected only once at the complex-shape reflector. In this manner, the concentration and/or crossover of the light beams can be obtained with reduced dimensions.

A favorable embodiment of the illumination system according to the invention is characterized in that the illumination system is provided with a slit, the concentration of light beams being substantially obtained at the location of the slit. The dimensions of the slit can be relatively small if the concentration and/or crossover if light beams are obtained at the location of the slit. Because most of the light emitted by the light emitters is directed away from the object, there is a chance that direct light might hit the eye of a viewer of the object to be illuminated. The occurrence of such unwanted light is reduced if the slit in the illumination system is a small as possible. To this end, a preferred embodiment of the illumination system according to the invention is characterized in that a width wₛ of the slit and a distance dₑᵣ between the light emitters and the complex-shape reflector meet the following relation:

$$\frac{{w}_{s}}{{d}_{er}} \leq 2.$$

Preferably, the plurality of light emitters is arranged along a straight line. In this embodiment, the illumination system is linear and also the complex-shape reflector is linearly shaped in one direction. If the illumination system has to be mounted on a shelf with certain roundness, the plurality of light emitters may, alternatively, be arranged along a curve line.

The invention also relates to a shelf-lighting system provided with such an illumination system. The shelf-lighting system comprises a first shelf holding an object and a second shelf arranged above the first shelf, an edge of the second shelf being provided with an illumination system according to the invention, the illumination system substantially homogenously illuminating the object.

The invention also relates to a wall-washer lighting system comprising such an illumination system. The wall-washer lighting system comprises an illumination system according to the invention, the object being a wall surface, the illumination system substantially homogenously illuminating the wall surface.

### BRIEF DESCRIPTION OF THE DRAWINGS

These and other aspects of the invention are apparent from and will be elucidated with reference to the embodiments described hereinafter.

In the drawings:

FIG. 1 is a cross-sectional view of an embodiment of the illumination system according to the invention;

FIG. 2 is a perspective view of the embodiment of the illumination system as shown in FIG. 1;

FIG. 3 shows a plurality of light beams in the embodiment of the illumination system as shown in FIG. 1;

FIG. 4 is a cross-sectional view of an alternative embodiment of the illumination system according to the invention;

FIG. 5 is a cross-sectional view of a further alternative embodiment of the illumination system according to the invention;

FIG. 6A shows the illumination as a function of the distance from a prior-art illumination system, and

FIG. 6B shows the illumination as a function of the distance from an illumination system according to the invention.

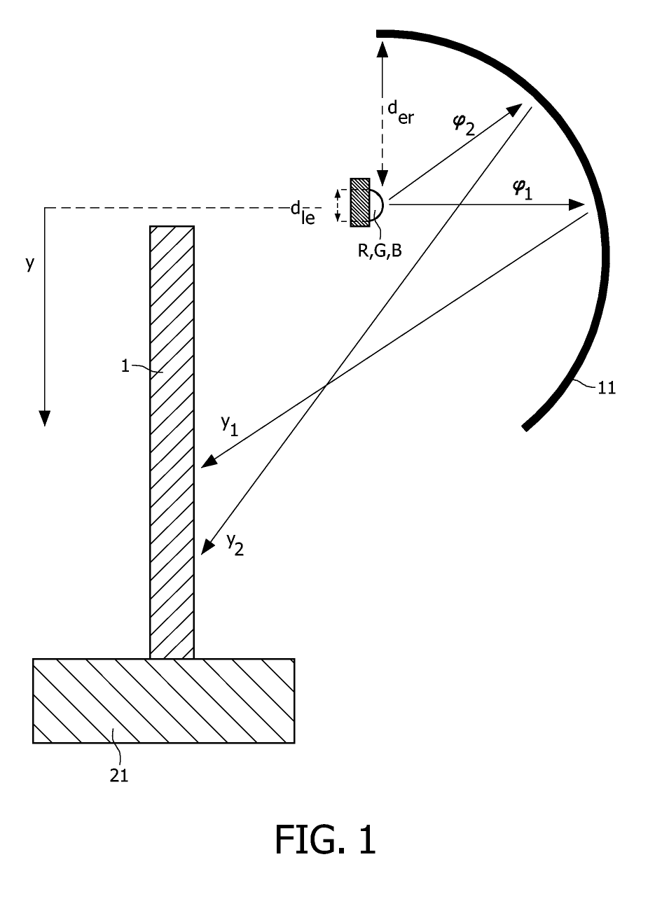

FIGS. 1, 2, 4 and 5 are purely diagrammatic and not drawn to scale. Notably, some dimensions are shown in a strongly exaggerated form for the sake of clarity. Similar components in the Figures are denoted as much as possible by the same reference numerals.

### DETAILED DESCRIPTION OF THE PREFERRED EMBODIMENTS

FIG. 1 schematically shows a cross-sectional view of an embodiment of the illumination system according to the invention. The illumination system comprises a plurality of light emitters R, G, B (only one LED is shown in FIG. 1), the light emitters substantially emitting light in a direction directed away from an object 1. In a preferred embodiment of the illumination system, no direct light emitted by the light emitters reaches the object. Very suitable light emitters are light-emitting diodes (LEDs). LEDs can be light sources of distinct primary colors, such as in the example of FIG. 1, the well-known red R, green G, or blue B light emitters. Alternatively, the light emitter can have, for example, amber or cyan as primary color. The primary colors may be either generated directly by the light-emitting-diode chip, or may be generated by a phosphor upon irradiance with light from the light-emitting-diode chip. In the latter case, also mixed colors or white light can act as one of the primary colors of the illumination system. Preferably, the LEDs are mounted on a (metal-core) printed circuit board.

LEDs have a light emission pattern which deviates from other light sources. A LED emits light in a half hemispherical part of space: all the light at the location of the LED chip is directed away from the face of the LED chip; no light is directed “backwards”.

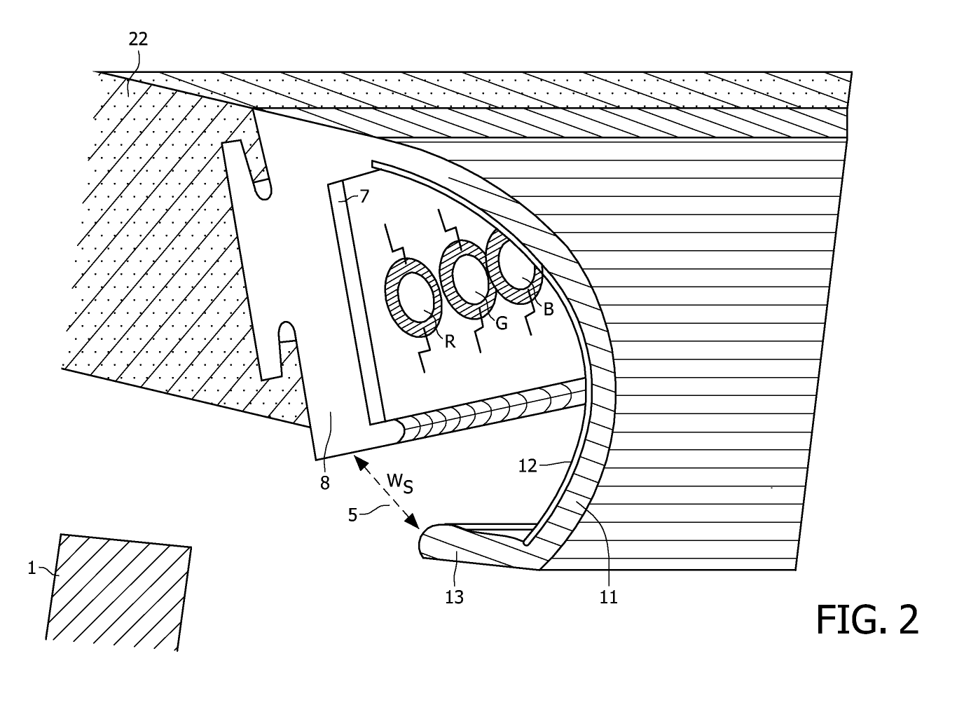

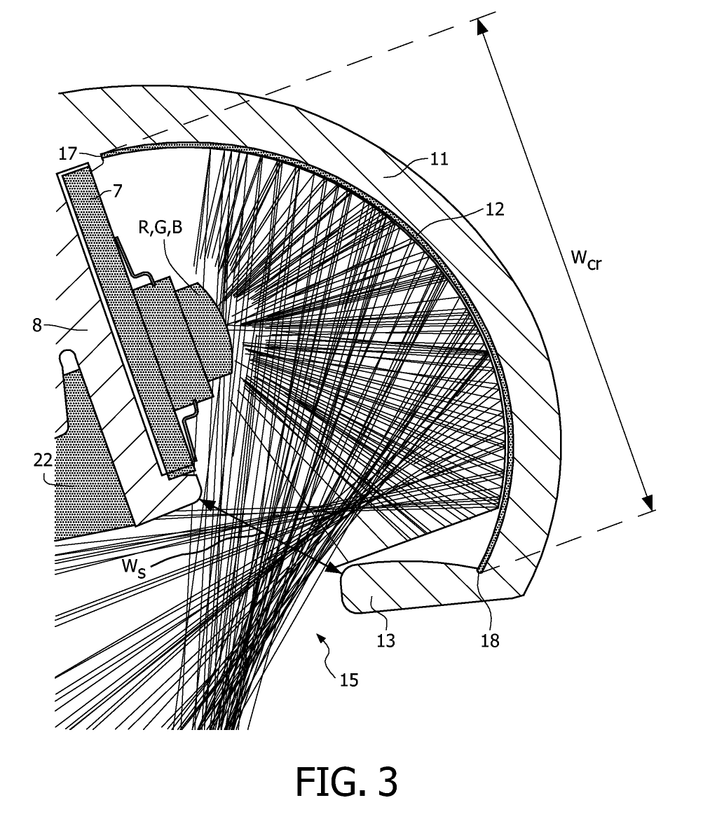

In general, the LEDs have a relatively high source brightness. Heat generated by the LEDs can be readily dissipated by heat conduction via the PCB. In a favorable embodiment of the illumination system, the (metal-core) printed circuit board is in contact with the housing (see FIGS. 2 and 3) of the illumination system via a heat-conducting connection. Preferably, so-called naked-power LED chips are mounted on a substrate 7, such as for instance an insulated metal substrate, a silicon substrate, a ceramic or a composite substrate. The substrate 7 provides electrical connection to the LED chip and acts as well as a good heat transfer to a heat exchanger.

The illumination system further comprises a complex-shape reflector 11 arranged in the vicinity of the plurality of light emitters R, G, B for reflecting light emitted by the plurality of light emitters R, G, B towards the object 1. The light emitters R, G, B and the complex-shape reflector 11 are arranged such with respect to each other and with respect to the object 1 that, in operation, light emitted by the plurality of light emitters R, G, B reaches the object 1 substantially only via the complex-shape reflector 11. The system of light emitters R, G, B and (the shape of) the complex-shape reflector 11 are designed such that the illumination system substantially homogenously illuminates the object 1. For illustration purposes a number of light rays emitted by the light emitters R, G, B and reflected by the complex-shape reflector 11 are shown. The object 1 to be illuminated by the illumination system in FIG. 1 is placed on a first shelf 21. Preferably, the illumination system comprising the light emitters R, G, B and the complex-shape reflector 11 are mounted on a second shelf 22 (see FIG. 2) arranged above the first shelf 21. In an alternative embodiment, the illumination system is mounted on the first shelf.

In FIG. 1, a characteristic dimension of the light emitters R, G, B is indicated with dₗₑ and a (shortest) distance dₑᵣ between the light emitters R, G, B and the complex-shape reflector 11 are indicated with dₑᵣ. Preferably, the size of the light emitters R, G, B is relatively small as compared to the distance dₑᵣ between the light emitters R, G, B and the complex-shape reflector 11. In a favorable embodiment of the illumination system according to the invention, the characteristic dimension dₗₑ of the light emitters R, G, B and the distance dₑᵣ between the light emitters R, G, B and the complex-shape reflector 11 meet the following relation:

$$\frac{{d}_{le}}{{d}_{er}} \leq 0.5 .$$

### Preferably,

$$\frac{{d}_{le}}{{d}_{er}} \leq 0.1 .$$

FIG. 2 very schematically shows a perspective view of the embodiment of the illumination system as shown in FIG. 1. The illumination system shown in FIG. 2 comprises a plurality of light emitters R, G, B arranged along a line for emitting light substantially away from the object 1. The wording “arrange along a line” is to be interpreted as a displacement of the light emitters along one direction.

The complex-shape reflector 11 arranged in the vicinity of the plurality of light emitters R, G, B reflects light emitted by the plurality of light emitters R, G, B towards the object 1. The arrangement of the light emitters R, G, B is such that the object 1 is illuminated by indirect light only.

The light emitters R, G, B are mounted on the substrate 7 providing electrical connection to the LED chip and acts as well as a good heat transfer to a heat exchanger. In the favorable embodiment of the illumination system according to the invention as shown in FIG. 2, the plurality of light-emitters R, G, B (mounted on the substrate 7) are arranged on a support 8. Preferably, the support 8 and the complex-shape reflector 11 are made from a single piece of metal. Preferably, the support 8 and the complex-shape reflector 11 are made from extruded aluminum.

Preferably, the complex-shape reflector 11 comprises a reflecting surface. Preferably, the reflective surface is partially diffusively reflecting. In an alternative embodiment the reflective surface is specularly reflecting. In the example of FIG. 2, the reflecting surface comprises a reflector foil 12 arranged in a clamping arrangement in the illumination system. An advantage of employing a reflector foil 12 is that a large choice of optical properties is possible. For instance, the reflective foil 12 can made with a desired reflectivity or scattering profile. Such a reflective foil 12 in itself may have insufficient strength. By inserting such a suitable reflective foil 12 into the preformed the complex-shape reflector, the reflective foil 12 will adapt to the shape of the complex-shape reflector. In an alternative embodiment the complex-shape reflector is provided with spacers supporting the reflective foil 12.

The object 1 to be illuminated by the illumination system in FIG. 1 can be placed on a first shelf (not shown in FIG. 2; see FIG. 1). Preferably, the illumination system comprising the light emitters R, G, B and the complex-shape reflector 11 are mounted on a second shelf 22 arranged above the object 1.

In the illumination system according to the invention, the light emitters R, G, B are, preferably, arranged along a straight line. In such an arrangement also the complex-shape reflector in one direction (perpendicular to its complex shape) is linearly shaped along a straight line. When the illumination system is mounted on the edge of a shelf with certain roundness, the plurality of light emitters may, alternatively, be arranged along a curve line. In principle, the complex-shape reflector in one direction follows the arrangement of the light emitters.

In the example of FIG. 2, the illumination system is provided with a relatively narrow slit 5. The slit 5 is an opening in the illumination system for emitting the light emitted by the light emitters R, G, B. In the example of FIG. 2, the complex-shape reflector is provided with a shielding means 13 narrowing the width of the slit 5. Preferably, the width wₛ of the slit 5 and the distance dₑᵣ between the light emitters R, G, B and the complex-shape reflector 11 meet the following relation:

$$\frac{{w}_{s}}{{d}_{er}} \leq 2.$$

### Preferably,

$$\frac{{w}_{s}}{{d}_{er}} \leq 1.$$

FIG. 3 shows a plurality of light beams in the embodiment of the illumination system as shown in FIG. 1. The quasi-elliptical shape of the complex-shape reflector 11 establishes a crossover and/or concentration 15 of light beams. Preferably, the concentration 15 of light beams being substantially obtained at the location of the slit 5. In the example of FIG. 3, the reflector foil 12 is clamped in a clamping arrangement in a first notch 17 of the complex-shape reflector 11 and in a second notch 18 between the complex-shape reflector and the shielding means 13.

It is pointed out that the drawing in FIG. 3 is drawn to scale. The shape of (the reflector foil 12 in) the complex-shape reflector resembles an actual shape. In the example of FIG. 3, the width wₛ of the slit 5 is approximately 12 mm and a characteristic dimension w_{cr} of the complex-shape reflector 11 is approximately 35 mm.

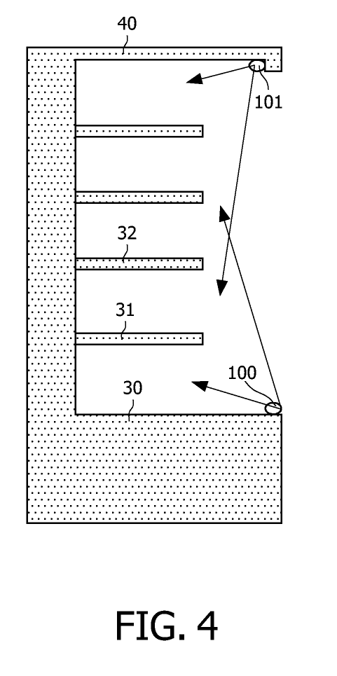

FIG. 4 schematically shows a cross-sectional view of an alternative embodiment of the illumination system according to the invention comprising with a plurality of shelves. In this embodiment, two illumination systems 100, 101 are mounted on a bottom shelf 30 and a top shelf 40. A plurality of shelves 31, 32, . . . is arranged between the bottom shelf 30 and a top shelf 40. Some light rays are shown for illumination objects to be placed on the bottom shelf 30 and/or the plurality of shelves 31, 32, . . .

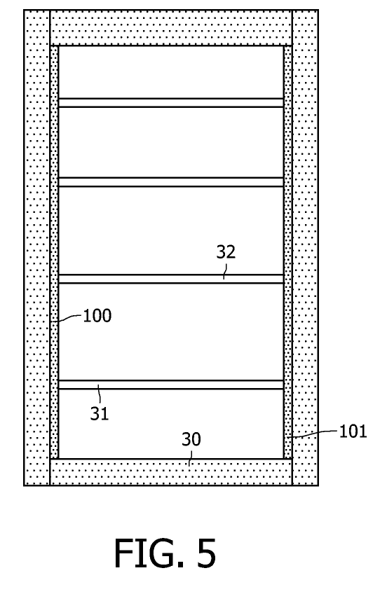

FIG. 5 schematically shows a cross-sectional view of a further alternative embodiment of the illumination system according to the invention with a plurality of shelves. In this embodiment, two illumination systems 100, 101 are mounted vertically adjacent a bottom shelf 30 and a plurality of shelves 31, 32, . . . A typical example where a vertical arrangement of the illumination systems 100, 101 is very suitable, is inside a refrigerator. The illumination systems may be mounted on a door or be mounted on walls of the refrigerator.

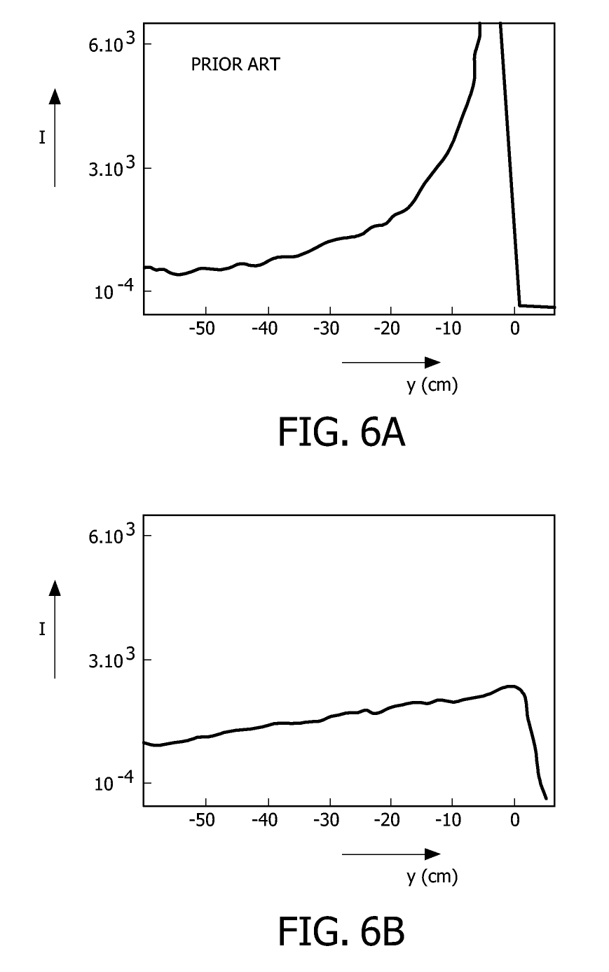

FIG. 6A shows the illumination as a function of the distance y from a prior-art illumination system. It can be seen that in the prior-art illumination system most of the light is projected in the relatively close vicinity of the illumination system whereas at distances further away from the illumination system relatively little light is projected. This results in a non-uniform illumination of the object, which is undesirable. In particularly, there is relatively much light on top of the object whereas the illumination on lower parts of the object, for instance, parts of the object facing the viewer, is relatively low, the amount of light rapidly diminishing from the top towards the bottom of the object.

FIG. 6B shows the illumination as a function of the distance y from an illumination system according to the invention (the y-axis is indicated in FIG. 1). It can be seen that in the illumination system according to the invention the combination of the plurality of light emitters R, G, B arranged along a line and the complex-shape reflector 11 provides a relatively uniform illumination of the object. Light emitted by the illumination system according to the invention distributes light relatively homogeneously over a certain target area.

The complex-shape reflector 11 is designed to reflect the light emitted by the light emitters R, G, B. The form of the complex-shape reflector 11 is optimized by well-known computer programs calculating the shape of the reflector dependent on the desired illumination of an object as a function of the distance between the object and the illumination system. In designing the complex-shape reflector the emitted ray angles φ₁ and φ₂ (see FIG. 1) by the complex-shape reflector are mapped onto respective positions y₁, y₂ (see FIG. 1) at the object 1 to be illuminated. In this manner, the ray density in the directions after reflection of the light emitted by the plurality of light-emitters can be varied allowing the target area to be illuminated in a desired manner. In principle the desired illumination is an input parameter for the calculation of the shape of the complex-shape reflector 11.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. An illumination system for illuminating an object arranged in the vicinity of the illumination system, the illumination system comprising:
a plurality of light emitters (R, G, B) arranged along a line for emitting light substantially away from the object,
a complex-shape reflector arranged in the vicinity of the plurality of light emitters (R, G, B) for reflecting light emitted by the plurality of light emitters (R, G, B) towards the object,
in operation, light emitted by the plurality of light emitters (R, G, B) substantially only reaching the object via the complex-shape reflector for substantially homogenously illuminating the object.

2. An illumination system as claimed in claim 1, wherein a characteristic dimension die of the light emitters (R, G, B) and a distance dₑᵣ between the light emitters (R, G, B) and the complex-shape reflector meet the following relation:
$$\frac{{d}_{le}}{{d}_{er}} \leq 0.5 .$$

3. An illumination system as claimed in claim 1, wherein the complex-shape reflector comprises an elliptical shape for obtaining a concentration of light beams.

4. An illumination system as claimed in claim 3, wherein the illumination system is provided with a slit, the concentration of light beams being substantially obtained at the location of the slit.

5. An illumination system as claimed in claim 4, wherein a width wₛ of the slit and a distance dₑᵣ between the light emitters (R, G, B) and the complex-shape reflector meet the following relation:
$$\frac{{w}_{s}}{{d}_{er}} \leq 2.$$

6. An illumination system as claimed in claim 1, wherein the complex-shape reflector comprises a reflecting surface.

7. An illumination system as claimed in claim 6, wherein the reflecting surface comprises a reflector foil arranged in a clamping arrangement in the illumination system.

8. An illumination system as claimed in claim 1 or 2, wherein the plurality of light-emitters (R, G, B) are arranged on a support (8), the support and the complex-shape reflector being made from a single piece of metal, preferably, extruded aluminum.

9. An illumination system as claimed in claim 1, wherein the plurality of light emitters (R, G, B) is arranged along a straight line.

10. An illumination system as claimed in claim 1, wherein the plurality of light emitters (R, G, B) comprises a plurality of light-emitting diodes of distinct primary colors or of a single primary color.

11. A shelf-lighting system comprising a first shelf holding an object and a second shelf arranged above the first shelf, an edge of the second shelf being provided with an illumination system as claimed in claim 1, the illumination system substantially homogenously illuminating the object (1).

12. A wall-washer lighting system comprising an illumination system as claimed in claim 1, the object being a wall surface, the illumination system substantially homogenously illuminating the wall surface.
